(19) United States
(12) Patent Application Publication
(10) Pub. No.: US 2014/0266654 A1
(43) Pub. Date: Sep. 18, 2014

(54) ANTI-TAMPERING SYSTEM FOR VEHICULAR COMPONENT

(71) Applicant: PAR-TECH, INC., Lake Orion, MI (US)

(72) Inventor: David W. Parker, Clarkston, MI (US)

(73) Assignee: PAR-TECH, INC., Lake Orion, MI (US)

(21) Appl. No.: 13/951,061

(22) Filed: Jul. 25, 2013

Related U.S. Application Data
(60) Provisional application No. 61/794,253, filed on Mar. 15, 2013.
(60) Provisional application No. 61/810,492, filed on Apr. 10, 2013.

(51) Int. Cl. B60R 25/30

(52) U.S. Cl. CPC B60R 25/30
USPC 340/426.25

(57) ABSTRACT

Anti-tampering systems, methods, and devices for protection of a vehicle component. An example anti-tampering system includes one or more sensors disposed proximate to the vehicle component and a controller in communication with the one or more sensors and a memory. The system further includes one or more processors configured to execute instructions stored in the memory to receive an alert signal from the one or more sensors. The alert signal is based on physical changes to the vehicle component meeting predetermined tamper criteria. The one or more processors are further configured to send an alarm command to one or more vehicle systems based on the alert signal.

### CROSS REFERENCE TO RELATED APPLICATIONS

This application claims priority to U.S. Provisional Patent Application Ser. No. 61/794,253 filed on Mar. 15, 2013 and U.S. Provisional Application Ser. No. 61/810,492 filed on Apr. 10, 2013, both of which are incorporated herein by reference.

### BACKGROUND

Some vehicular components are targeted for removal or theft due to the value of construction materials. For example, a catalytic converter can include precious metals such as platinum, rhodium, and palladium that can be sold by thieves to scrap metal dealers. For vehicles having bodies in elevated positions, such as trucks or sport-utility vehicles, the unwanted removal of a catalytic converter can occur very quickly, sometimes in less than a few minutes. Existing theft-prevention systems can be subject to removal along with the vehicle component. In addition, existing theft-prevention systems are not designed to sound an alarm or send a notification to the owner of the vehicle or the authorities until the component is already removed from the vehicle, thus the alarm or notification is too late to stop the theft. Existing theft-prevention systems are not sufficient theft deterrents.

### SUMMARY

Anti-tampering systems, methods, and devices for protection of a vehicle component are disclosed. In one embodiment, an anti-tampering system for protection of a vehicle component is disclosed. The anti-tampering system includes one or more sensors disposed proximate to the vehicle component and a controller in communication with the one or more sensors and a memory. The system further includes one or more processors configured to execute instructions stored in the memory to receive an alert signal from the one or more sensors. The alert signal is based on physical changes to the vehicle component meeting predetermined tamper criteria. The one or more processors are further configured to send an alarm command to one or more vehicle systems based on the alert signal.

In another embodiment, an anti-tampering sensor for protecting a vehicle component is disclosed. The anti-tampering sensor includes a memory and one or more processors configured to execute instructions stored in the memory to receive data related to physical changes to the vehicle component. The processors are further configured to compare the data received to predetermined tamper criteria. If the data received fit the predetermined tamper criteria, the processors are further configured to send an alert signal based on the predetermined tamper criteria to a controller. The controller is configured to send an alarm command to one or more vehicle systems based on the alert signal. If the data received do not fit the predetermined tamper criteria, the anti-tampering sensor can be configured to sleep until additional data is received.

In another embodiment, a method of protecting a vehicle component is disclosed. The method includes receiving, from one or more sensors, data related to physical changes to the vehicle component. The method further includes comparing the data received to a predetermined tamper criteria and, if the data received fit the predetermined tamper criteria, sending an alarm command to one or more vehicle systems and an external device.

### BRIEF DESCRIPTION OF THE DRAWINGS

The description herein makes reference to the accompanying drawings wherein like reference numerals refer to like parts throughout the several views, and wherein:

FIG. 1 is a schematic view of an anti-tampering system for protection of a vehicle component;

FIG. 2 is a process flow diagram describing example operations of one or more sensors included in the anti-tampering system of FIG. 1; and

FIG. 3 is a process flow diagram describing example operations of the anti-tampering system of FIG. 1.

### DETAILED DESCRIPTION

The anti-tampering system disclosed here deters tampering with or theft of vehicle components. The anti-tampering system include sensors mounted proximate to vehicle components to be monitored that can detect motion, vibration, and/or other physical changes to a vehicle component and send an alert signal to a controller. The controller can send an alarm command to various vehicle systems, such as the lighting system or horn system. The controller can also send an alarm command to an external device if one is associated with the anti-tampering system, for example, a smart phone of the vehicle owner or response request system of local authorities. The combination of notifications that alert both the potential thief and the owner or authorities of tampering as it occurs can minimize instances of actual theft.

FIG. 1 is a schematic view of an anti-tampering system 10 for protection of one or more vehicle components, such as catalytic converters 12a-b. In general, the anti-tampering system 10 operates when a vehicle including the one or more vehicle components to be protected is not itself operating, as the driver of the vehicle would be present to monitor the vehicle during its operation. The anti-tampering system 10 can include a controller 14. The controller 14 can be any type of vehicle-installed, handheld, or other form of computing device, or can be composed of multiple computing devices. The controller 14 can include or be coupled to a conventional central processing unit (CPU) or any other type of device, or multiple devices, capable of manipulating or processing information. The controller 14 can also include or be coupled to a memory for storing data and program instructions used by the CPU. The memory can be a random access memory device (RAM) or any other suitable type of storage device. The memory can include data that is accessed by the CPU using a bus. The memory can also include an operating system and installed applications, the installed applications including programs that permit the CPU to perform the anti-tampering methods described here.

The anti-tampering system 10 can also include one or more sensors, such as sensors 16a and/or 16b in direct or indirect communication with the controller 14 and located proximate to the one or more vehicle components to be protected. For example, sensor 16a can be located near enough to catalytic converter 12a and sensor 16b can be located near enough to catalytic converter 12b such that the sensors 16a-b are able to detect physical changes in the catalytic converters 12a-b such as movement, rotation, vibration, change in orientation, or other indications of change in position or physical properties of the catalytic converter 12a. In some embodiments, the sensors 16a-b can be also be configured to detect presence and absence of the catalytic converters 12a-b. The sensors 16a-b can capture data for processing by the controller, an inertial measurement unit (IMU), an odometry or dead-reckoning system, a light detection and ranging system (LIDAR), or any other type of system or device capable of detecting movement, determining position, detecting presence or absence, and outputting signals to the CPU of the controller 14.

The sensors 16a-b can be part of existing vehicle components or sensors or independent sensors designed specifically to implement the anti-tampering methods described here. If the sensors 16a-b used are existing sensors, they can be located in close proximity to the catalytic converters 12a-b and be monitored for high frequency current acting in a manner similar to the inductor sensors described below. Example existing sensors include, but are not limited to, throttle position, fuel pressure, temperature, back pressure, oxygen, coolant temperature, and mass airflow input sensors.

In one or more embodiments, the sensors 16a-b can be intelligent sensors. Intelligent sensors can be accelerometers, electro-magnetic sensors, radio frequency identification (RFID) receivers and tags, LIDAR sensors, or any other type of sensors configured to detect presence and/or physical changes in one or more of the catalytic converters 12a-b. By detecting physical changes in the one or more catalytic converters 12a-b, such as changes in position, orientation, or vibration, the sensors can 16a-b provide an indication of attempted tampering with the catalytic converters 12a-b before the catalytic converters 12a-b are actually removed from the vehicle, more effectively deterring theft of the catalytic converters 12a-b.

In one example of intelligent sensors, the sensors 16a-b are RFID sensors and an RFID transmitter/receiver can be mounted nearby the catalytic converters 12a-b to interrogate a passive RFID tag/receiver mounted on the catalytic converters 12a-b. The frequency of interrogations can be configured using the controller 14. When an interrogation takes place, the RF transmitter can request a response from the tag/receiver. The signal strength and response time can be used to determine both presence and movement of the catalytic converters 12a-b. In another example of intelligent sensors, the sensors 16a-b are LIDAR sensors configured to capture and process laser returns. Laser returns can include backscattered light reflected by the catalytic converters 12a-b and other proximate physical objects. The sensors 16a-b can calculate intensity values and reflectivity based on these laser returns for various points on the catalytic converters 12a-b in order to determine the position of the catalytic converters 12a-b.

In another example, the sensors 16a-b can be non-intelligent sensors, that is, sensors having a status monitored by another device. In one example of non-intelligent sensors, the sensors 16a-b are inductive sensors and any movement of the catalytic converters 12a-b can be determined by the controller 14 based on a change in inductance of an inductor placed within range of the sensors 16a-b adhered to or proximate to the catalytic converters 12a-b. The design and placement of the inductor can be such that it is sensitive to both movement and presence and can filter out surrounding metallic components.

In another example of non-intelligent sensors, the sensors 16a-b can be resistance-based sensors where the resistance across a wire loop is monitored by the controller 14 to movement in position of one or more of the catalytic converters 12a-b. The presence or absence of resistance can also be used to determine presence or absence of the catalytic converters 12a-b. In this example, wiring can be run from the controller 14 to one or more of the catalytic converters 12a-b. One or more heat-tolerant resistors capable of being adhered to at least one of the catalytic converters 12a-b can be configured to generate resistance on the wire. The resistors can be adhered in such a manner that any attempt at separating the wire from the catalytic converters 12a-b will break the wire before breaking the adherence to the catalytic converters 12a-b. In order to allow for breakage of the wire before removal of adherence, brittle wire, connectors within the wire loop, or other means can be used. A further description of the example operation of the various types of sensors 16a-b is provided in respect to FIG. 2 below.

The controller 14 of the anti-tampering system 10 can also be in communication with one or more vehicle systems 18. For example, the controller 14 can be in communication with the vehicle lighting system, the control system or wiring harness associated with the horn, or a separate vehicle system associated with a unique alarm function dedicated to the anti-tampering system 10. Each of the vehicle systems 18 in communication with the controller 14 can be configured to perform a specific action depending on the alarm command received from the controller 14. For example, the external headlamps and brake lamps can be configured to flash on and off for a predetermined period of time if an alarm command is received from the controller 14.

The controller 14 of the anti-tampering system 10 can also be in direct or indirect communication with one or more external devices 20 that have been associated with the anti-tampering system 10. For example, the controller 14 can be in communication with a handheld device such as a smart phone configured to provide notifications regarding the status of the anti-tampering system 10 to the operator of the handheld device, in this example, the owner or operator of the vehicle. Example notifications can include phone calls with recorded messages, text messages, system-tray messages, sounded alarms, or any other notification configured to indicate the status of the vehicle component being monitored by the anti-tampering system 10. In another example, the controller 14 can be in communication with an external device 20 associated with crime-prevention authorities, such as the police, or private security personnel. In this example, the external device 20 can be configured to pinpoint the location of the anti-tampering system, giving nearby crime-prevention authorities the ability to interfere with a theft in progress.

The controller 14 of the anti-tampering system 10 can also be in communication with a maintenance interface 22 configured to receive a user input that generates a command configured to suspend operation of the anti-tampering system 10 for a predetermined period of time. For example, a switch, button, or electronic control panel with soft buttons can be located inside the vehicle. The maintenance interface 22 allows a mechanic, or the vehicle owner, needing to perform maintenance on the vehicle component being protected, or another vehicle component proximate the one or more of the sensors 16a-b, to indicate that the anti-tampering system 10 should be deactivated for a given period of time. If the maintenance interface 22 includes a display, the amount of time remaining during the deactivation can be displayed, such that the mechanic can be aware of when the anti-tampering system will be re-enabled and can extend the time period by another input to the maintenance interface 22.

FIG. 2 is a process flow diagram describing example operations of one or more sensors 16a-b included in the anti-tampering system 10 of FIG. 1. In one embodiment, the sensors 16a-b can be intelligent sensors. For example, sensor 16a can include or be in communication with a intelligent sensor such as an accelerometer, electro-magnetic sensor, LIDAR sensor, RFID sensor, or other intelligent sensor and one or more processors for controlling the operations of the sensor 16a and evaluating the intelligent sensor's signal. The sensors 16a-b can also include or be in communication with a memory for storing data and program instructions used by the one or more processors. In another embodiment, the sensors 16a-b can be non-intelligent sensors, sending signals to one or more external processors and memory. In one embodiment, the sensors 16a-b can be enclosed in a stiff, non-conductive material housed within a polymer case rigidly affixed to a structure containing the protected vehicle component to ensure that any motion experienced by the sensors 16a-b matches that experienced by the protected vehicle component. For example, sensor 16a can be located proximate to, that is, near enough to the catalytic converter 12a to capture the motion of the catalytic converter 12a.

In an example embodiment using intelligent sensors, the one or more processors in the sensors 16a-b can be configured to execute the instructions stored in the memory to receive data related to the vehicle component. The data received can indicate that the catalytic converters 12a-b are presently moving, rotating, vibrating, or changing position in any manner. The one or more processors in the sensors 16a-b can be further configured to compare the data received to predetermined tamper criteria. The predetermined tamper criteria can include, for example, distance, duration, magnitude, and frequency thresholds related to motion of the catalytic converters 12a-b. The predetermined tamper criteria, that is, the ranges or specific events indicating tampering, can be established through empirical evidence and be based on the exact type of sensors 16a-b used, the packaging of the sensors 16a-b in relation to the vehicle components being protected, and the type of vehicle component being protected.

If the one or more sensors 16a-b receive data that fit or meet the predetermined tamper criteria, the one or more sensors 16a-b can send an alert signal to the controller 14. However, if the one or more sensors 16a-b receives data that do not fit or meet the predetermined tamper criteria, the one or more sensors 16a-b can be configured to sleep until additional data is received. In one embodiment designed to conserve energy, the sensors 16a-b can transmit signals only when a tamper event is detected. In another embodiment, the one or more sensors 16a-b can be configured to transmit signals when no tamper event is detected and stop transmission when a tamper event is detected. In the example embodiment using non-intelligent sensors, the controller 14 can compare the signals or data received from the one or more sensors 16a-b to the predetermined tamper criteria to determine when a tamper event is detected.

FIG. 3 is process flow diagram describing example operations of the anti-tampering system 10 of FIG. 1. In one embodiment, the anti-tampering system 10 operates when a vehicle including the vehicle component being protected is not operating or is stationary. The controller 14 of the anti-tampering system 10 can be securely fastened within the cab of the vehicle including the vehicle component to be monitored. The maintenance interface 22 or any on/off power features associated with the anti-tampering system 10 can be mounted in the vehicle in such a manner as to allow users to interact with them easily, but also in a location such that those who are unaware of the anti-tamper system 10 would be precluded from easily finding it.

When the vehicle is not operating or is stationary, the controller 14 of the anti-tampering system 10 can monitor the sensors 16a-b both for an alert signal and for loss of communication. A loss of communication with one or more of the sensors 16a-b can indicate that the sensors 16a-b have been removed from the vehicle or any physical wiring associated with the sensors 16a-b has been cut or disabled. In the cases where an alert signal is received, including an alert signal indicating a loss of communication with one of the sensors 16a-b, the controller 14 can send an alarm command to one or more vehicle systems.

There can be different types of alarm commands depending on the specific embodiment of the anti-tampering system 10. In one example, an alarm command can be sent to an external vehicle lighting system, the external vehicle lighting system being configured to flash the headlamps and brake lamps on and off for a predetermined period of time once the alarm command is received from the controller 14. In another example, an alarm command can be sent to the horn, and the horn can be configured to honk for a predetermined period of time once the alarm command is received from the controller 14. Each vehicle system 18 in communication with the controller 14 can be configured to perform a specific action depending on the alarm command received from the controller 14. In addition, multiple alarm commands can be sent by the controller 14 to different vehicle systems 18.

If an external device 20 is associated with the anti-tampering system 10, the controller 14 can send an alarm command to the external device 20. Various external devices 20 can been associated with the anti-tampering system 10. For example, the owner of the vehicle can interact with the controller 14, though a direct interface or remote interface, to establish a communication link with a handheld device such as a smart phone. The controller 14 can be configured to send, as an alarm command, a signal initiating a notification on the smart phone regarding the status of the anti-tampering system 10 to the operator of the handheld device, in this example, the owner of the vehicle. As described above, the external device 20 can be configured to include example notifications such as phone calls with recorded messages, text messages, system-tray messages, sounded alarms, or any other notification configured to indicate the status of the vehicle component being monitored by the anti-tampering system 10.

In another example, the external device 20 can be one that is associated with crime-prevention authorities, such as the police, or private security personnel. In this example, and as described above, the external device 20 can be configured to pinpoint the location of the anti-tampering system, giving nearby crime-prevention authorities the ability to interfere with a theft in progress. More than one external device 20 can be associated with the anti-tampering system 10. For example, both the owner of the vehicle and select crime-prevention authorities could be notified at the same time based on multiple alarm commands.

The example operations of the anti-tampering system 10 process flow of FIG. 3 also include determining whether a maintenance mode has been engaged. If the controller 14 determines that the owner, a mechanic, or other person has properly interacted with the maintenance interface 22 as described in FIG. 1, the anti-tampering system 10 can be deactivated, or put to sleep, for a specified period of time such that an alarm command will not be sent even if one or more of the sensors 16a-b detect data that fits the tamper criteria. In one example, the maintenance interface 22 is a button that can be pressed to indicate a single hour of anti-tampering system 10 sleep time. The button can also be configured to be pressed again to add an hour to the anti-tampering system 10 sleep time within a maximum limit set in the controller 14. The maximum limit can be set to ensure that the anti-tampering system 10 is not left off for an overnight period. As described above, the maintenance interface can also be a simple on/off switch, or an electronic display allowing the mechanic or operator to set a specific sleep time for the anti-tampering system 10 and to monitor the sleep time while maintaining the vehicle.

In addition, the anti-tampering system 10 can be configured to regulate its own power consumption by entering periodic sleep modes to ensure that the vehicle battery, if the vehicle battery powers the anti-tampering system 10, is not depleted. The sleep modes can be based both on power consumption and on time of day. For example, the sleep modes can be restricted to daylight hours to ensure that the anti-tampering system 10 is operating during nighttime hours when theft is more likely.

The embodiments of the controller 14 (and the algorithms, methods, instructions etc. stored thereon and/or executed thereby) can be realized in hardware including, for example, intellectual property (IP) cores, application-specific integrated circuits (ASICs), programmable logic arrays, optical processors, programmable logic controllers, microcode, firmware, microcontrollers, servers, microprocessors, digital signal processors or any other suitable circuit. In the claims, the term “processor” should be understood as encompassing any the foregoing, either singly or in combination. The terms “signal” and “data” are used interchangeably. Further, portions of the controller 14 do not necessarily have to be implemented in the same manner.

In one embodiment, the controller 14 can be implemented using general purpose computers/processors with a computer program that, when executed, carries out any of the respective methods, algorithms and/or instructions described herein. In addition or alternatively, for example, special purpose computers/processors can be utilized which can contain other hardware for carrying out any of the methods, algorithms, or instructions described herein.

Further, all or a portion of embodiments of the present disclosure can take the form of a computer program product accessible from, for example, a non-transitory computer-usable or computer-readable medium. A non-transitory computer-usable or computer-readable medium can be any device that can, for example, tangibly contain, store, communicate, or transport the program for use by or in connection with any processor. The non-transitory medium can be, for example, an electronic, magnetic, optical, electromagnetic, or a semiconductor device. Other suitable mediums are also available.

The foregoing description relates to what are presently considered to be the most practical embodiments. It is to be understood, however, that the disclosure is not to be limited to these embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. An anti-tampering system for protection of a vehicle component, comprising:
one or more sensors disposed proximate to the vehicle component;
a controller in communication with the one or more sensors and a memory; and
one or more processors configured to execute instructions stored in the memory to:
receive an alert signal from the one or more sensors, the alert signal based on physical changes to the vehicle component meeting predetermined tamper criteria; and
send an alarm command to one or more vehicle systems based on the alert signal.

2. The system of claim, wherein the one or more processors are further configured to:
if an external device is associated with the anti-tampering system, send the alarm command to the external device.

3. The system of claim 2, wherein the external device is configured to send a notification to a vehicle owner based on the alarm command.

4. The system of claim 2, wherein the external device is configured to send a notification to one or more crime-prevention authorities based on the alarm command.

5. The system of claim 1, wherein the one or more sensors include:
a memory:
one or more processors configured to execute instructions stored in the memory to:
receive data related to the vehicle component;
compare the data received to the predetermined tamper criteria;
if the data received fit the predetermined tamper criteria, send the alert signal to the controller; and
if the data received do not fit the predetermined tamper criteria, sleep until additional data is received.

6. The system of claim 1, wherein the physical changes to the vehicle component include at least one of a vibration of the vehicle component or change in position of the vehicle component.

7. The system of claim 1, wherein the alert signal is further based on at least one of activation or deactivation of the one or more sensors, change in status of the one or more sensors, or absence of the vehicle component.

8. The system of claim 1, wherein the anti-tampering system operates when a vehicle including the vehicle component being protected is not operating.

9. The system of claim 1, further comprising:
a maintenance interface configured to receive a user input that generates a command configured to suspend operation of the anti-tampering system for a predetermined period of time.

10. An anti-tampering sensor for protecting a vehicle component, comprising:
a memory; and
one or more processors configured to execute instructions stored in the memory to:
receive data related to physical changes to the vehicle component;
compare the data received to a predetermined tamper criteria;
if the data received fit the predetermined tamper criteria, send an alert signal based on the predetermined tamper criteria to a controller wherein the controller is configured to send an alarm command to one or more vehicle systems based on the alert signal; and
if the data received do not fit the predetermined tamper criteria, sleep until additional data is received.

11. The anti-tampering sensor of claim 10, wherein the physical changes to the vehicle component include at least one of a vibration of the vehicle component or change in position of the vehicle component.

12. The anti-tampering sensor of claim 10, wherein the controller is further configured to send the alarm command to an external device.

13. The anti-tampering sensor of claim 12, wherein the external device is configured to send a notification to a vehicle owner based on the alarm command.

14. The anti-tampering sensor of claim 12, wherein the external device is configured to send a notification to one or more crime-prevention authorities based on the alarm command

15. The anti-tampering sensor of claim 10, wherein the one or more processors are further configured to:
receive, from a maintenance interface, a command configured to suspend the comparison of data received to the predetermined tamper criteria for a predetermined period of time.

16. The anti-tampering sensor of claim 10, wherein the anti-tampering sensor operates when a vehicle including the vehicle component being protected is not operating.

17. A method of protecting a vehicle component, comprising:
receiving, from one or more sensors, data related to physical changes to the vehicle component;
comparing the data received to a predetermined tamper criteria; and
if the data received fit the predetermined tamper criteria, sending an alarm command to one or more vehicle systems and an external device.

18. The method of claim 17, wherein the external device is configured to send a notification to a vehicle owner based on the alarm command.

19. The method of claim 17, wherein the external device is configured to send a notification to one or more crime-prevention authorities based on the alarm command.

20. The method of claim 17, further comprising:
receiving, from a maintenance interface, a command configured to suspend the comparison of data received to the predetermined tamper criteria for a predetermined period of time.
